(19) United States
(12) Patent Application Publication
(10) Pub. No.: US 2025/0282936 A1
(43) Pub. Date: Sep. 11, 2025

(54) NANOCELLULOSE COMPOSITION PRODUCED FROM A COTTON-RICH TEXTILE PRODUCT AND APPLICATIONS THEREOF

(71) Applicant: Harvest Nano Inc., Ann Arbor, MI (US)

(72) Inventor: Refael Aharon, Ann Arbor, MI (US)

(21) Appl. No.: 18/724,192

(22) PCT Filed: Apr. 3, 2024
(86) PCT No.: PCT/US24/22841

§ 371 Date: Jun. 26, 2024

Related U.S. Application Data
(60) Provisional application No. 63/493,958, filed on Apr. 3, 2023.

(51) Int. Cl. C08L 1/02; B33Y 80/00; C09D 7/40; C09D 101/02; D21H 11/14; D21H 11/18

(52) U.S. Cl. CPC C08L 1/02; B33Y 80/00; C09D 7/70; C09D 101/02; D21H 11/14; D21H 11/18; C08L 2205/16; C08L 2207/20

(57) ABSTRACT

A nanocellulose composition produced from a cotton-rich textile product is disclosed. The nanocellulose composition comprises a nanocellulose content of 2% to 99% by weight of the nanocellulose composition, a synthetic fiber content of 0.001% to 3% by weight of the nanocellulose composition, and a mineral content of less than 9% by weight of the nanocellulose composition. An average particle size of the nanocellulose composition is in a range of 1 nanometer (nm) to 250 nanometers (nm). A caloric value of the nanocellulose composition is in a range of 100 kilojoules (kJ) to 1803 kilojoules (kJ) or 20 kilocalories (kcal) to 360 kilocalories (kcal)/100 grams (g). Applications of the nanocellulose composition are also disclosed.

### CROSS-REFERENCE TO RELATED APPLICATIONS

The present application is a U.S. National Stage Application, filed under 35 U.S.C. § 371, of International Patent Application No. PCT/US2024/022841, filed on Apr. 3, 2024, which claims priority to U.S. Provisional Patent Application No. 63/493,958, filed on Apr. 3, 2023, the entireties of which are incorporated herein by reference for all purposes.

### TECHNICAL FIELD

The present disclosure relates generally to nanocellulose compositions and, more particularly, to a nanocellulose composition produced from a cotton-rich textile product and applications of such a nanocellulose composition.

### BACKGROUND

This section provides background information related to the present disclosure which is not necessarily prior art.

Textile products containing cotton can be considered “cotton-rich” if the textile products have at least 25 wt. %. or greater cotton content. In this regard, textile products made from cotton, such as clothing or other textile products, contain mainly cellulose fibers, as the cellulose content of cotton is over 90 wt. %. As such, an abundance of cellulose can be found in new or used cotton-made clothing (i.e., white or colored) or other cotton-made textile products. Used cotton-made textile products, which mainly include used cotton-made clothing, is increasingly being collected and dumped into landfills or other places in relatively large quantities as post-consumer textile waste (PCTW), even though such used cotton-made textile products contain an abundance of cellulose as mentioned. Such an increase of post-consumer textile waste (PCTW) is a growing problem which negatively impacts the environment.

Cellulose is a well-organized fibrillar arrangement that is primarily responsible for the mechanical strength of plants. Cellulose is considered to be one of the most abundant organic compounds derived from plant biomass. In this regard, most cellulose is produced naturally by plants, with total amounts exceeding 500 billion metric tons each year worldwide. Cellulose biopolymers are used in various industries which produce various types of products. Although cellulose is a polysaccharide, its crystallinity is imperfect such that a significant portion of the cellulose structure is less active and can be referred to as amorphous.

The degree of crystallinity of native cellulose usually ranges from 40% to 70% depending on the origin of the cellulose and the isolation method. The cellulose is present in the form of the microfibrils, which are bound together by lignin and hemicellulose. These microfibrils are very fine fibrils (i.e., fiber-like strands) having a width of 10-50 micrometers (μm). Cellulose is a natural stable polymer, containing a hydrogen bond network, which does not dissolve in common aqueous solvents and has a 60-270° C./500-518° F./533-543 K melting point.

Nanocellulose, discovered in 1980, is a relatively new material which is substantially different than cellulose. Nanocellulose is obtained by removing the amorphous parts (i.e., lignin and hemicellulose) from cellulose and downsizing the active cellulose fibers such that only the active nano scale parts remain. In this regard, nanocellulose is comprised of cellulose molecules with at least one dimension in nanoscale (1-250 nanometers (nm)) and with known properties of nanocellulose (e.g., zeta potential, strength, weight, etc.). The characteristic properties of nanocellulose, including crystallinities, surface area, zeta potential, and mechanical properties, vary with the extraction methods and processing techniques which produce the nanocellulose. Such characteristic properties of nanocellulose typically depend on the technique and synthesis conditions of the nanocellulose, which determines its dimensions, composition, and properties. One core reason for the appeal of nanocellulose since its discovery is that material with a higher uniformity and fewer defects with enhanced mechanical properties can be achieved by extracting the nanocellulose from cellulosic material. Nanocellulose is a natural biodegradable material. Pure nanocellulose is nontoxic for people and it is biocompatible. Nanocellulose-based materials are carbon-neutral, nontoxic, sustainable, and recyclable.

Over the years, the production (i.e., commercial or large-scale production) of nanocellulose (i.e., nanocellulose compositions) has been limited and is considered to be relatively expensive due to the costs of raw cellulosic materials, equipment, and production processes. Despite the considerable potential of nanocellulose, a relatively low quantity of nanocellulose is produced each year worldwide. In this regard, there is currently an increased focus on cost-effective production of nanocellulose, especially since research has increasingly shown nanocellulose to provide many advantages in a wide range of applications in various industries. As one example, nanocellulose is believed to be a replacement for synthetic materials due to having superior mechanical properties and being more environmentally-friendly. In this regard, recent developments have shown the ability to increase the strength of various polymeric products in various industries with the addition of nanocellulose particles (i.e., additives) so that such polymeric products exhibit admirable mechanical properties. Such recent developments have led to substantial growth and increasing demand for nanocellulose.

Given at least what is discussed above, nanocellulose is considered to be a high-value, promising, relatively new material with a wide range of potential applications.

Considering at least the above-mentioned positives and advantages relating to nanocellulose, as well as the substantial growth and increasing demand for nanocellulose, there is currently an unaddressed need for nanocellulose compositions (i.e., produced in a large-scale, cost-effective, and environmentally-friendly manner) and applications of such nanocellulose compositions.

### SUMMARY

This section provides a general summary of the present disclosure and is not a comprehensive disclosure of its full scope or all of its features.

The present disclosure aims to address at least the aforementioned need for nanocellulose compositions and applications of such nanocellulose compositions. More specifically, the present disclosure provides at least a nanocellulose composition produced from a cotton-rich textile product, applications of the nanocellulose composition, and a method of producing the nanocellulose composition (i.e., advantageously in a large-scale, cost-effective, and environmentally-friendly manner).

According to at least one embodiment, a nanocellulose composition produced from a cotton-rich textile product comprises a nanocellulose content of 2% to 99% by weight of the nanocellulose composition, a synthetic fiber content of 0.001% to 3% by weight of the nanocellulose composition, and a mineral content of less than 9% by weight of the nanocellulose composition. An average particle size of the nanocellulose composition is in a range of 1 nanometer (nm) to 250 nanometers (nm). A caloric value of the nanocellulose composition is in a range of 100 kilojoules (kJ) to 1803 kilojoules (kJ) or 20 kilocalories (kcal) to 360 kilocalories (kcal)/100 grams (g).

According to at least one embodiment, the nanocellulose composition further comprises a hemicellulose content of 0.01% to 3% by weight of the nanocellulose composition.

According to at least one embodiment, the nanocellulose composition further comprises a plastic content of less than 0.04% by weight of the nanocellulose composition.

According to at least one embodiment, the nanocellulose composition further comprises a textile dye chemical content of 0.001% to 0.03% by weight of the nanocellulose composition.

According to at least one embodiment, the nanocellulose composition further comprises a textile detergent content of less than 0.1% by weight of the nanocellulose composition.

According to at least one embodiment, the nanocellulose composition further comprises a sand content of less than 1% by weight of the nanocellulose composition.

According to at least one embodiment, the nanocellulose composition further comprises a dirt content of less than 0.2% by weight of the nanocellulose composition.

According to at least one embodiment, the nanocellulose composition further comprises a metal content of less than 1% by weight of the nanocellulose composition.

According to at least one embodiment, the nanocellulose composition may be produced from a dry cotton-rich textile product. The dry cotton-rich textile product is a feedstock used for producing the nanocellulose composition. A relative humidity (RH) of the feedstock is 35% or less.

According to at least one embodiment, the dry cotton-rich textile product may be new or used cotton-rich clothing.

According to at least one embodiment, the nanocellulose composition may be produced from a wet cotton-rich textile product. The wet cotton-rich textile product is a feedstock used for producing the nanocellulose composition. A relative humidity (RH) of the feedstock is greater than 35%.

According to at least one embodiment, the wet cotton-rich textile product may be cotton-rich textile wastewater.

According to at least one embodiment, the nanocellulose composition may be in the form of a powder or a gel.

According to at least one embodiment, the nanocellulose composition may be used for producing at least one selected from the group consisting of a textile product, viscose, lyocell, a packaging product, a pulp or paper product, a plastic product, a 3D-printed product, a medical product, a sports product, a military product, an automobile component, an electric vehicle battery component, an aerospace product, a coating product, a construction product, a toy product, an additive used for producing and improving a polymer, an additive used for producing a resin used for 3D printing, and an additive used for producing a metal composition.

According to at least one embodiment, a textile product comprises the nanocellulose composition.

According to at least one embodiment, the textile product may be viscose or lyocell.

According to at least one embodiment, a packaging product comprises the nanocellulose composition.

According to at least one embodiment, a pulp or paper product comprises the nanocellulose composition.

According to at least one embodiment, a plastic product comprises the nanocellulose composition.

According to at least one embodiment, a 3D-printed product comprises the nanocellulose composition.

According to at least one embodiment, a medical product comprises the nanocellulose composition.

According to at least one embodiment, a sports product comprises the nanocellulose composition.

According to at least one embodiment, a military product comprises the nanocellulose composition.

According to at least one embodiment, an automobile component comprises the nanocellulose composition.

According to at least one embodiment, an electric vehicle battery component comprises the nanocellulose composition.

According to at least one embodiment, an aerospace product comprises the nanocellulose composition.

According to at least one embodiment, a coating product comprises the nanocellulose composition.

According to at least one embodiment, a construction product comprises the nanocellulose composition.

According to at least one embodiment, a toy product comprises the nanocellulose composition.

According to at least one embodiment, an additive used for producing and improving a polymer comprises the nanocellulose composition.

According to at least one embodiment, an additive used for producing a resin used for 3D printing comprises the nanocellulose composition.

According to at least one embodiment, an additive used for producing a metal composition comprises the nanocellulose composition.

### BRIEF DESCRIPTION OF THE DRAWINGS

The present disclosure will become more fully understood from the detailed description and the accompanying drawings, wherein:

FIG. 1 is a block diagram schematically illustrating various examples of applications of a nanocellulose composition, according to at least one embodiment;

FIG. 2 is a table and graph illustrating an average particle size distribution of the nanocellulose composition, according to at least one embodiment;

FIG. 3 is a flow chart schematically illustrating a method (i.e., process) of producing the nanocellulose composition from a cotton-rich textile product, according to at least one embodiment; and

FIG. 4 are pictures illustrating examples of cotton-rich textile products used for producing the nanocellulose composition, and the nanocellulose composition in both powder and gel forms, according to at least one embodiment.

### DETAILED DESCRIPTION

As required, one or more detailed embodiments of the present disclosure are disclosed herein, however, it is to be understood that the disclosed one or more embodiments are merely illustrative of the present disclosure that may be embodied in various and alternative forms. Therefore, specific details disclosed herein are not to be interpreted as limiting, but merely as a representative basis for teaching those skilled in the art to variously employ the present disclosure.

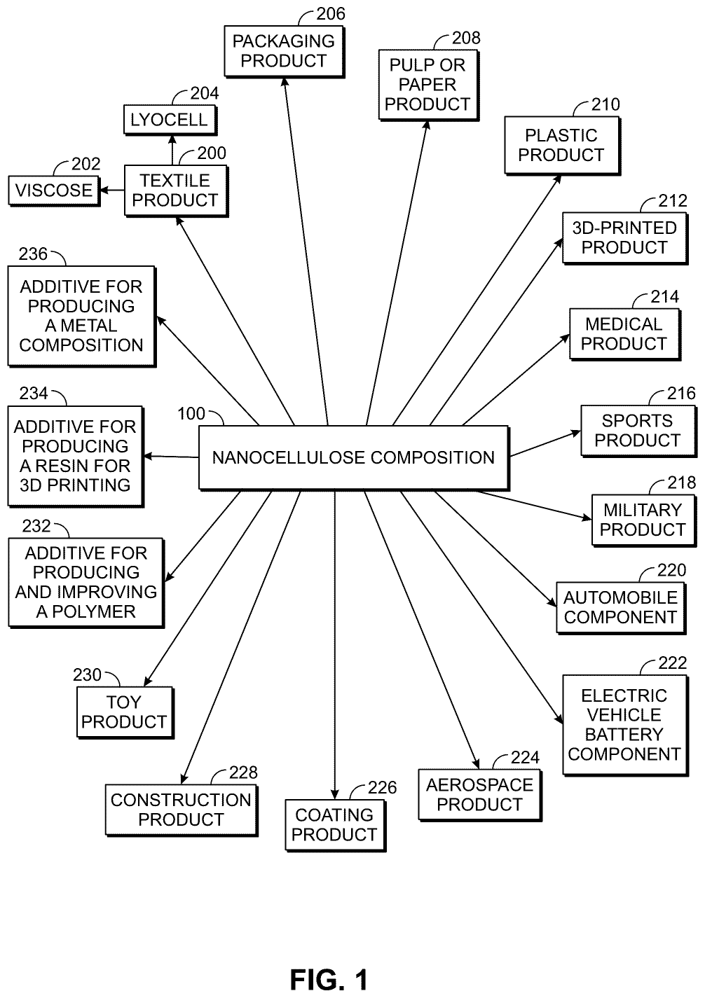

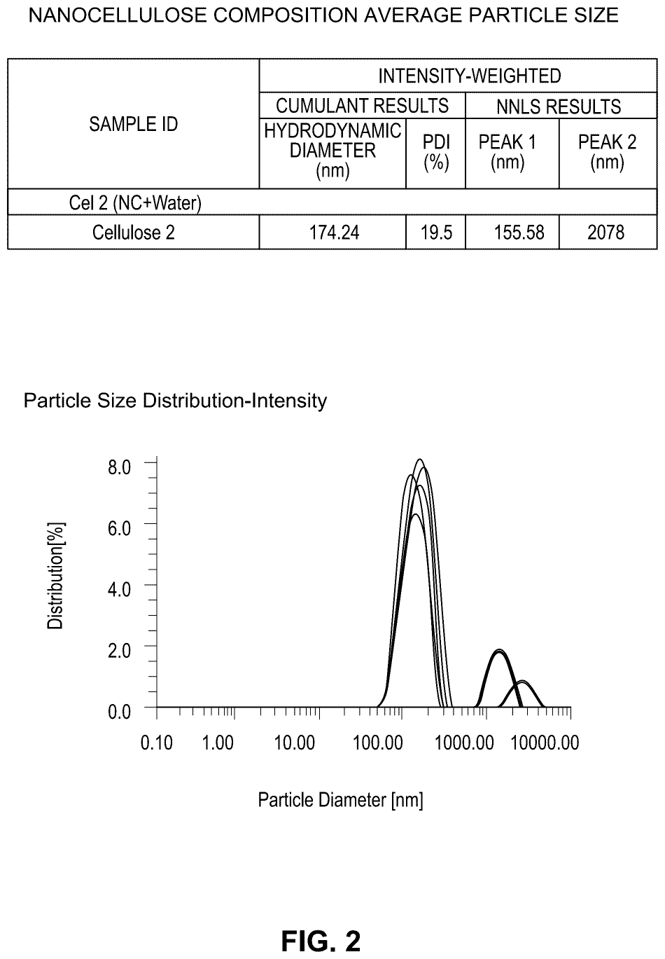

Referring generally to the figures, and particularly to FIGS. 1, 2 and 4, according to at least one embodiment, a nanocellulose composition 100 produced from a cotton-rich textile product is schematically shown and further described herein. According to the present disclosure, a textile product that is referred to as “cotton-rich” contains at least 25 wt. %. or greater cotton content. As will be evident to those skilled in the art, the nanocellulose composition 100 advantageously has a wide range of applications, as will be further described herein.

According to at least one embodiment, the nanocellulose composition 100 comprises a nanocellulose content of 2% to 99% by weight of the nanocellulose composition 100, a synthetic fiber (e.g., polyester) content of 0.001% to 3% by weight of the nanocellulose composition 100, and a mineral (e.g., ash) content of less than 9% by weight of the nanocellulose composition 100. An average particle size of the nanocellulose composition 100 is in a range of 1 nanometer (nm) to 250 nanometers (nm). A caloric value of the nanocellulose composition 100 is in a range of 100 kilojoules (kJ) to 1803 kilojoules (kJ) or 20 kilocalories (kcal) to 360 kilocalories (kcal)/100 grams (g).

According to at least one embodiment, the nanocellulose composition 100 further comprises a hemicellulose content of 0.01% to 3% by weight of the nanocellulose composition 100.

According to at least one embodiment, the nanocellulose composition 100 further comprises a plastic (e.g., plastic particles, such as PLA particles, PVC particles, PET particles, or other plastic particles) content of less than 0.04% by weight of the nanocellulose composition 100.

According to at least one embodiment, the nanocellulose composition 100 further comprises a textile dye chemical (e.g., clothing dye chemicals, fabric dye chemicals, or other textile dye chemicals) content of 0.001% to 0.03% by weight of the nanocellulose composition 100.

According to at least one embodiment, the nanocellulose composition 100 further comprises a textile detergent (e.g., clothing laundry detergents or other detergents used for washing fabrics and other textiles) content of less than 0.1% by weight of the nanocellulose composition 100.

According to at least one embodiment, the nanocellulose composition 100 further comprises a sand (e.g., sand particles) content of less than 1% by weight of the nanocellulose composition 100.

According to at least one embodiment, the nanocellulose composition 100 further comprises a dirt (e.g., dirt particles) content of less than 0.2% by weight of the nanocellulose composition 100.

According to at least one embodiment, the nanocellulose composition 100 further comprises a metal (e.g., metal particles, such as iron particles, copper particles, nickel particles, or other metal particles) content of less than 1% by weight of the nanocellulose composition 100.

While various numerical values of contents (i.e., in percent (%) by weight (wt. %) of the nanocellulose composition 100) and other numerical values (i.e., for average particle size of the nanocellulose composition 100 and caloric value of the nanocellulose composition 100) are described herein, it is to be understood by those skilled in the art that such numerical values are not limited to those as described herein, and may vary from those described herein.

According to at least one embodiment, the nanocellulose composition 100 may be produced from a dry cotton-rich textile product. In this regard, the dry cotton-rich textile product is a feedstock used for producing the nanocellulose composition 100. As a non-limiting example, a relative humidity (RH) of the feedstock (i.e., dry cotton-rich textile product) is 35% or less.

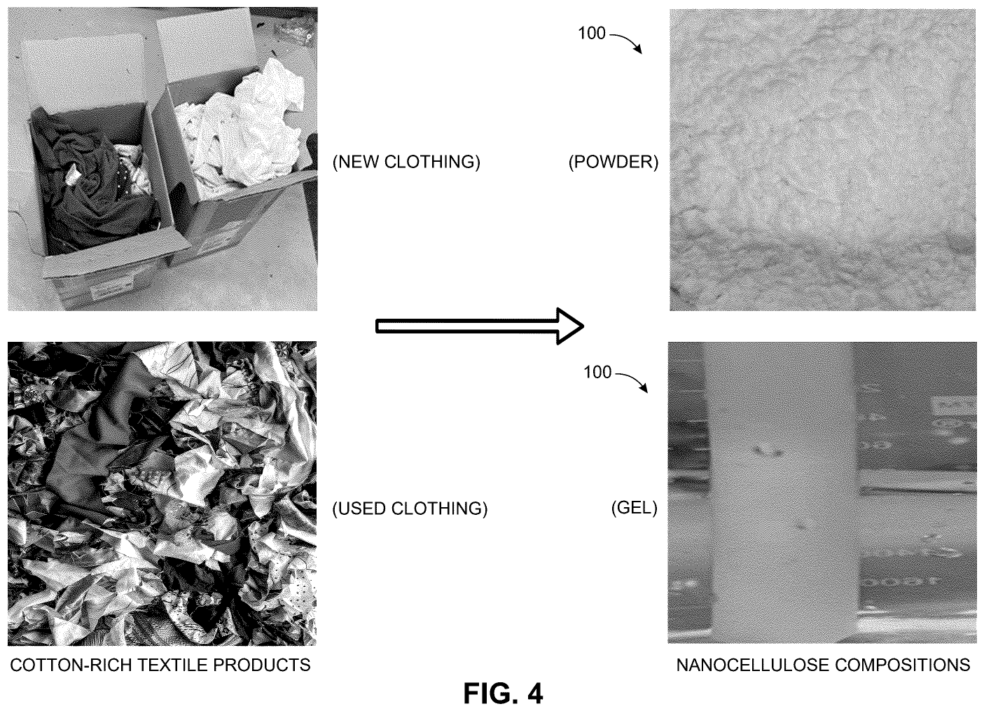

According to at least one embodiment, as shown in FIG. 4, as non-limiting examples, the dry cotton-rich textile product may be new or used cotton-rich clothing (i.e., white or colored), cotton-rich fabrics, or other dry cotton-rich textile products.

According to at least one embodiment, the nanocellulose composition 100 may be produced from a wet cotton-rich textile product. In this regard, the wet cotton-rich textile product is a feedstock used for producing the nanocellulose composition 100. As a non-limiting example, a relative humidity (RH) of the feedstock (i.e., wet cotton-rich textile product) is greater than 35%.

According to at least one embodiment, as a non-limiting example, the wet cotton-rich textile product may be cotton-rich textile wastewater.

As shown in FIG. 4, according to at least one embodiment, the nanocellulose composition 100 may be in the form of a powder (i.e., dry solid) or a gel (i.e., liquid). In this regard, as non-limiting examples, the nanocellulose composition 100 may be packaged in various pouches, boxes, containers, etc. containing the powder or gel forms before being shipped or distributed for use in a wide range of applications, as will be further described herein.

As shown in FIG. 1, the nanocellulose composition 100 advantageously has a wide range of applications, and may be used for producing various products in various industries, as will be further described herein. Similarly, the nanocellulose composition 100 advantageously may be used for producing various additives used for producing various products in various industries, as will be further described herein. In this regard, according to at least one embodiment, as non-limiting examples, the nanocellulose composition 100 may be used for producing at least one selected from the group consisting of a textile product 200, viscose 202, lyocell 204, a packaging product 206, a pulp or paper product 208, a plastic product 210, a 3D-printed product 212, a medical product 214, a sports product 216, a military product 218, an automobile component 220, an electric vehicle battery component 222, an aerospace product 224, a coating product 226, a construction product 228, a toy product 230, an additive 232 used for producing and improving a polymer, an additive 234 used for producing a resin used for 3D printing, and an additive 236 used for producing a metal composition. The use of the nanocellulose composition 100 is not limited and therefore may be used for producing various products and additives other than the aforementioned non-limiting examples, as may be understood by those skilled in the art.

As further shown in FIG. 1, according to at least one embodiment, a textile product 200 comprises the nanocellulose composition 100. As non-limiting examples, the textile product 200 which comprises the nanocellulose composition 100 may be any one of a number of textile products, such as various clothing (e.g., apparel, garments, headwear, etc.), bags, fabrics, fibers, yarns, threads, etc. As further shown in FIG. 1, according to at least one embodiment, the textile product 200 which comprises the nanocellulose composition 100 may be viscose 202 or lyocell 204. Viscose 202 and lyocell 204 are semi-synthetic fibers that are commonly used for producing various other textile products. In this regard, it is to be understood by those skilled in the art that the viscose 202 or lyocell 204 which comprises the nanocellulose composition 100 are improved or enhanced forms of viscose or lyocell (i.e., with enhanced or improved mechanical strength or other mechanical properties), rather than typical or standard forms of viscose or lyocell. Moreover, other forms or types of semi-synthetic fibers generally equivalent to viscose or lyocell may comprise the nanocellulose composition 100. As may be understood by those skilled in the art, the textile product 200 which comprises the nanocellulose composition 100 is not limited to the aforementioned non-limiting examples, as many other textile products may comprise the nanocellulose composition 100.

As further shown in FIG. 1, according to at least one embodiment, a packaging product 206 comprises the nanocellulose composition 100. As non-limiting examples, the packaging product 206 which comprises the nanocellulose composition 100 may be any one of a number of packaging products, such as various containers, lids, bottles, tubes, drums, pouches, bags, boxes, shipping protection fillers, envelopes, mailers, etc. As may be understood by those skilled in the art, the packaging product 206 which comprises the nanocellulose composition 100 is not limited to the aforementioned non-limiting examples, as many other packaging products may comprise the nanocellulose composition 100.

As further shown in FIG. 1, according to at least one embodiment, a pulp or paper product 208 comprises the nanocellulose composition 100. As non-limiting examples, the pulp or paper product 208 which comprises the nanocellulose composition 100 may be any one of a number of pulp or paper products, such as various tissue papers, toilet papers, paper towels, napkins, paper filters, notepads, copy papers, photo papers, coated papers, gift wraps, cardstocks, envelopes, paper plates, paper cups, paper straws, cardboards, boxes, etc. As may be understood by those skilled in the art, the pulp or paper product 208 which comprises the nanocellulose composition 100 is not limited to the aforementioned non-limiting examples, as many other pulp or paper products may comprise the nanocellulose composition 100.

As further shown in FIG. 1, according to at least one embodiment, a plastic product 210 comprises the nanocellulose composition 100. As non-limiting examples, the plastic product 210 which comprises the nanocellulose composition 100 may be any one of a number of plastic products, such as various products that are primarily or entirely made of plastic (e.g., injection-molded plastic products, blow-molded plastic products, thermoformed plastic products, extruded plastic products, etc.), plastic resins, plastic sheets, plastic wrapping, biodegradable plastics, plastic industrial products, plastic household products, etc. As may be understood by those skilled in the art, the plastic product 210 which comprises the nanocellulose composition 100 is not limited to the aforementioned non-limiting examples, as many other plastic products may comprise the nanocellulose composition 100.

As further shown in FIG. 1, according to at least one embodiment, a 3D-printed product 212 comprises the nanocellulose composition 100. As non-limiting examples, the 3D-printed product 212 which comprises the nanocellulose composition 100 may be any one of a number of 3D-printed products, such as various 3D-printed prototype products, architectural models, aerospace components, automotive components, tools, jewelry, eyeglass frames, phone products (e.g., phone stands or holders, phone cases, etc.) vases, wall art, wall mounts, game or movie miniatures, toys, gadgets, etc. As may be understood by those skilled in the art, the 3D-printed product 212 which comprises the nanocellulose composition 100 is not limited to the aforementioned non-limiting examples, as many other 3D-printed products may comprise the nanocellulose composition 100.

As further shown in FIG. 1, according to at least one embodiment, a medical product 214 comprises the nanocellulose composition 100. As non-limiting examples, the medical product 214 which comprises the nanocellulose composition 100 may be any one of a number of medical products, such as various mobility aids (e.g., wheelchairs, walking aids, etc.), medical electronics housings, medical packaging, single-use medical products (e.g., single-use tubes, syringes, catheters, lancets, bandages, gloves, etc.), surgical tools, sutures, bags (e.g., blood bags, IV bags, waste bags, etc.), medical tubing, implants (e.g., heart valve components, knee and hip replacement components, etc.), prosthetics, orthodontics (e.g., retainers, aligners, etc.), etc. As may be understood by those skilled in the art, the medical product 214 which comprises the nanocellulose composition 100 is not limited to the aforementioned non-limiting examples, as many other medical products may comprise the nanocellulose composition 100.

As further shown in FIG. 1, according to at least one embodiment, a sports product 216 comprises the nanocellulose composition 100. As non-limiting examples, the sports product 216 which comprises the nanocellulose composition 100 may be any one of a number of sports products, such as various football equipment (e.g., helmets, padding, cleats, footballs, etc.), baseball equipment (e.g., helmets, cleats, bats, baseballs, gloves, practice netting, etc.), basketball equipment (e.g., basketball nets, backboards, basketballs, etc.), hockey equipment (e.g., helmets, skate components, pucks, netting, etc.), soccer equipment (e.g., cleats, soccer balls, netting, etc.), lacrosse equipment (e.g., cleats, helmets, heads, sticks, balls, netting, etc.), golf equipment (e.g., tees, golf balls, golf club components, training aids, practice netting, etc.), fishing equipment (e.g., fishing lures, fishing rods, fishing lines, tackle boxes, fish netting, etc.), winter sports equipment (e.g., skis, ski poles, snowboards, helmets, goggles, etc.), shooting equipment, archery equipment, tennis equipment (e.g., tennis racquet strings, netting, etc.), racquetball equipment (e.g., racquet strings, etc.), martial arts equipment (e.g., punching or kicking bags, etc.), swimming equipment (e.g., divider buoys, goggles, diving boards, etc.), exercise equipment (e.g., exercise devices, machines, etc.), cycling equipment (e.g., cycling helmets, bicycle components, etc.), watersports equipment (e.g., surfboards, etc.), etc. As may be understood by those skilled in the art, the sports product 216 which comprises the nanocellulose composition 100 is not limited to the aforementioned non-limiting examples, as many other sports products may comprise the nanocellulose composition 100.

As further shown in FIG. 1, according to at least one embodiment, a military product 218 (e.g., for use in military defense, law enforcement, etc.) comprises the nanocellulose composition 100. As non-limiting examples, the military product 218 which comprises the nanocellulose composition 100 may be any one of a number of military products, such as various protective gear (e.g., helmets, bullet-proof vests, boots, eyewear, shields, etc.), military-grade ropes or ties, firearm components (e.g., grips, butt stocks, handguards, pistol frames, optic mounts, magazines, recoil pads, trigger guards, lower receivers, picatinny rails, etc.), military vehicle components, surveillance equipment, etc. As may be understood by those skilled in the art, the military product 218 which comprises the nanocellulose composition 100 is not limited to the aforementioned non-limiting examples, as many other military products may comprise the nanocellulose composition 100.

As further shown in FIG. 1, according to at least one embodiment, an automobile component 220 comprises the nanocellulose composition 100. As non-limiting examples, the automobile component 220 which comprises the nanocellulose composition 100 may be any one of a number of automobile components, such as various automobile interior components (e.g., dashboards, interior trim, interior door panels, interior mirrors, driver interface control buttons or knobs, center consoles, storage netting, etc.), automobile exterior components (e.g., front grills, front bumpers, rear bumpers, exterior door trim, exterior mirrors, headlamp housings and lenses, tail lamp housings and lenses, etc.), automobile wire harness clips, automobile battery housings, automobile sensor housings, automobile fuse compartments, tools for repairing automobiles, etc. As may be understood by those skilled in the art, the automobile component 220 which comprises the nanocellulose composition 100 is not limited to the aforementioned non-limiting examples, as many other automobile components may comprise the nanocellulose composition 100.

As further shown in FIG. 1, according to at least one embodiment, an electric vehicle battery component 222 comprises the nanocellulose composition 100. As non-limiting examples, the electric vehicle battery component 222 which comprises the nanocellulose composition 100 may be any one of a number of electric vehicle battery components, such as various battery housing components (e.g., battery tray top and bottom covers, etc.), battery module boxes and lids, side frame insert energy absorbers, etc. As may be understood by those skilled in the art, the electric vehicle battery component 222 which comprises the nanocellulose composition 100 is not limited to the aforementioned non-limiting examples, as many other electric vehicle battery components may comprise the nanocellulose composition 100.

As further shown in FIG. 1, according to at least one embodiment, an aerospace product 224 comprises the nanocellulose composition 100. As non-limiting examples, the aerospace product 224 which comprises the nanocellulose composition 100 may be any one of a number of aerospace products, such as various aircraft components (e.g., dashboard enclosures, cockpit visors, seating components, video bezels, light lenses, window shades, ceiling and wall panels, flooring, mirrors, counter backsplashes, toilets, beverage carts, radomes, nose cones, etc.), aircraft cargo containers, etc. As may be understood by those skilled in the art, the aerospace product 224 which comprises the nanocellulose composition 100 is not limited to the aforementioned non-limiting examples, as many other aerospace products may comprise the nanocellulose composition 100.

As further shown in FIG. 1, according to at least one embodiment, a coating product 226 comprises the nanocellulose composition 100. As non-limiting examples, the coating product 226 which comprises the nanocellulose composition 100 may be any one of a number of coating products, such as various polymeric coatings, powder coatings, paints (e.g., interior and exterior paints, etc.), films (e.g., abrasion-resistant films, etc.), tapes, etc. As may be understood by those skilled in the art, the coating product 226 which comprises the nanocellulose composition 100 is not limited to the aforementioned non-limiting examples, as many other coating products may comprise the nanocellulose composition 100.

As further shown in FIG. 1, according to at least one embodiment, a construction product 228 comprises the nanocellulose composition 100. As non-limiting examples, the construction product 228 which comprises the nanocellulose composition 100 may be any one of a number of construction products, such as various paints, waterproofing membranes, sealants, roofing and floor coatings, pipes, insulations, foams, adhesives, cladding, building materials, construction tools, etc. As may be understood by those skilled in the art, the construction product 228 which comprises the nanocellulose composition 100 is not limited to the aforementioned non-limiting examples, as many other construction products may comprise the nanocellulose composition 100.

As further shown in FIG. 1, according to at least one embodiment, a toy product 230 comprises the nanocellulose composition 100. As non-limiting examples, the toy product 230 which comprises the nanocellulose composition 100 may be any one of a number of toy products, such as various video gaming system consoles or controller components, dolls, figurines, toy cars or trucks, toy houses, toy tools (e.g., toy hammers, toy saws, etc.), toy widgets (e.g., finger traps, crawling helical springs, etc.), toy guns or ammo, board game pieces, educational toys, water toys, ride-on toys, ring toys, block toys, etc. As may be understood by those skilled in the art, the toy product 230 which comprises the nanocellulose composition 100 is not limited to the aforementioned non-limiting examples, as many other toy products may comprise the nanocellulose composition 100.

As further shown in FIG. 1, according to at least one embodiment, an additive 232 used for producing and improving a polymer comprises the nanocellulose composition 100. In this regard, as a non-limiting example, the additive 232 which comprises the nanocellulose composition 100 may be added to any suitable or desired polymer resin to advantageously improve or enhance various mechanical properties (e.g., mechanical strength, etc.) of the polymer resin during the production of the polymer resin, as may be understood by those skilled in the art.

As further shown in FIG. 1, according to at least one embodiment, an additive 234 used for producing a resin used for 3D printing comprises the nanocellulose composition 100. In this regard, as a non-limiting example, the additive 234 which comprises the nanocellulose composition 100 may be added to any suitable or desired resin used for 3D printing to advantageously improve or enhance various mechanical properties (e.g., mechanical strength, etc.) of the resin used for 3D printing during the production of the resin used for 3D printing, as may be understood by those skilled in the art.

As further shown in FIG. 1, according to at least one embodiment, an additive 236 used for producing a metal composition comprises the nanocellulose composition 100. In this regard, as a non-limiting example, the additive 236 which comprises the nanocellulose composition 100 may be added to any suitable or desired metal composition to advantageously improve or enhance various mechanical properties (e.g., mechanical strength, etc.) of the metal composition during the production of the metal composition, as may be understood by those skilled in the art.

With further regard to the various aforementioned products, components, and additives which comprise the nanocellulose composition 100, such products and components, at least in part, may be produced from a wide range of suitable materials, such as known or available polymers, or other materials. In this regard, when such aforementioned products and components are produced (e.g., at a manufacturing site), the nanocellulose composition 100 may be added to or mixed with one or more suitable materials, such as polymers (e.g., polymer resins), during the production process (e.g., using injection molding or other processes). Alternatively, the one or more polymers (e.g., polymer resins) from which such products and components may be produced may already comprise the nanocellulose composition 100 since the nanocellulose composition 100 may be in itself an additive to various polymers (e.g., polymer resins) before they are used for producing such products and components. In any case, the various aforementioned products, components, and additives which comprise the nanocellulose composition 100 may advantageously benefit from having improved or enhanced mechanical properties (e.g., mechanical strength, etc.), while being lighter weight, etc.

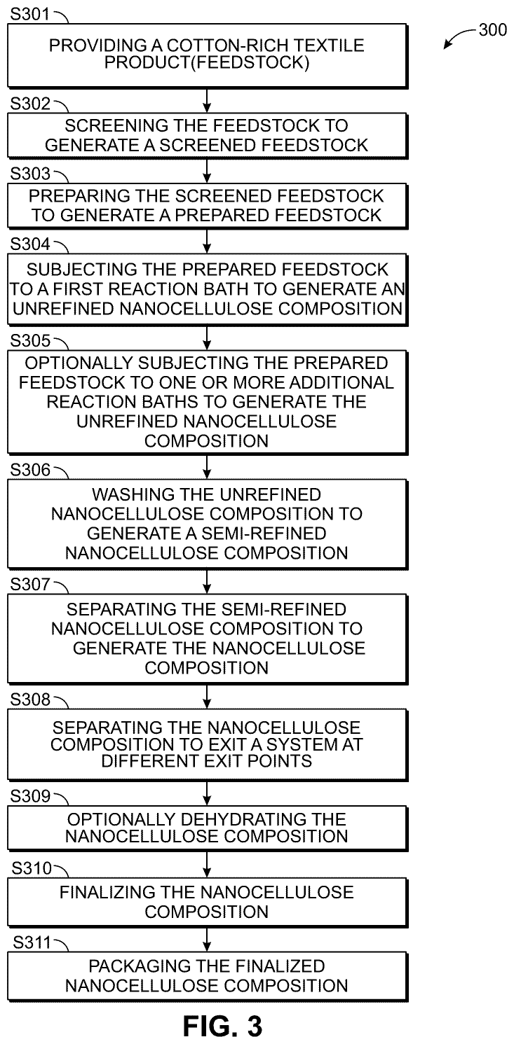

Referring to FIG. 3, according to at least one embodiment, a method 300 of producing the nanocellulose composition 100 from a cotton-rich textile product is schematically shown and further described herein. As will become evident to those skilled in the art, the method 300 is advantageously capable of at least producing the nanocellulose composition 100 in a manner which is large-scale, cost-effective, and environmentally-friendly. Moreover, it is to be understood by those skilled in the art that the method 300 may be carried out in any desired or appropriate production environment (e.g., relatively large or small production facilities) and by using any production system, machine, equipment, etc. as desired or deemed appropriate.

As shown in FIG. 3, the method 300 begins at step S301 thereof. According to at least one embodiment, step S301 of the method 300 includes providing a cotton-rich textile product. As previously mentioned, according to the present disclosure, a textile product that is referred to as “cotton-rich” contains at least 25 wt. %. or greater cotton content. Since the cellulose content of cotton is over 90 wt. %., cotton-rich textile products advantageously contain an abundance of cellulose. In this regard, the cotton-rich textile product is a feedstock (e.g., raw material) used for producing the nanocellulose composition 100. As non-limiting examples, as shown in FIG. 4, the cotton-rich textile product (i.e., feedstock) may be a dry cotton-rich textile product such as various new or used cotton-rich clothing (i.e., white or colored), cotton-rich fabrics, or other dry cotton-rich textile products. As a non-limiting example, a relative humidity (RH) of the dry cotton-rich textile product (i.e., feedstock) is 35% or less. Further, as a non-limiting example, the cotton-rich textile product (i.e., feedstock) may be a wet cotton-rich textile product, such as cotton-rich textile wastewater. As a non-limiting example, a relative humidity (RH) of the wet cotton-rich textile product (i.e., feedstock) is greater than 35%. The cotton-rich textile product that may be provided is not limited to the aforementioned non-limiting examples, as other various cotton-rich textile products may be provided as a feedstock used for producing the nanocellulose composition 100, as may be understood by those skilled in the art.

For purposes of further describing the method 300 herein, the cotton-rich textile product will now be referred to as “the feedstock” since the cotton-rich textile product is the feedstock (e.g., raw material) used for producing the nanocellulose composition 100, as previously mentioned.

As further shown in FIG. 3, once the feedstock has been provided from step S301, the method 300 may proceed to step S302 thereof. According to at least one embodiment, step S302 of the method 300 includes screening the feedstock to generate a screened feedstock. In this regard, according to at least one embodiment, the step S302 of screening the feedstock to generate the screened feedstock may include characterizing the feedstock as solid or liquid, dry or wet, analyzing the feedstock, and removing unwanted matter from the feedstock (i.e., cleaning the feedstock).

More specifically, with further regard to step S302 of the method 300, the feedstock may be characterized as solid or liquid, dry or wet. With further regard to step S302 of the method 300, once the feedstock has been characterized such that the feedstock has been determined to be solid or liquid, dry or wet, the feedstock may be analyzed. According to at least one embodiment, as non-limiting examples, analyzing the feedstock may include determining at least one of the weight, density, chemical composition, water/moisture content (i.e., relative humidity) (RH), acidity (pH), or electrical conductivity (EC) of the feedstock. Other qualities and quantities of the feedstock may be analyzed, and are not limited to the aforementioned non-limiting examples. Moreover, such analyzed qualities and quantities of the feedstock may be determined or measured by scales, moisture analyzers, Spectro methods, or by using optics methods. With further regard to step S302 of the method 300, once the feedstock has been analyzed, unwanted matter may be removed from the feedstock. According to at least one embodiment, as non-limiting examples, removing the unwanted matter from the feedstock may include removing (i.e., at least some or most of, as 100% removal may or may not be feasible or possible) at least one of metal particles (e.g., iron particles, copper particles, nickel particles, or other metal particles), plastic particles (e.g., PLA particles, PVC particles, PET particles, or other plastic particles), synthetic fibers (e.g., polyester), glass particles, dust particles, sand particles, dirt particles, construction aggregate particles, dead skin particles, ions, hair particles, fats, oils, textile detergents (e.g., clothing laundry detergents or other detergents used for washing fabrics and other textiles), or textile dye chemicals (e.g., clothing dye chemicals, fabric dye chemicals, or other textile dye chemicals) from the feedstock. Other unwanted matter may be removed from the feedstock, and is not limited to the aforementioned non-limiting examples. The various unwanted matter may be removed from the feedstock by way of various equipment, processes, or techniques. For example, to remove metal particles, a magnet is preferably used. Additionally, gravity, a centrifuge, or precipitation could be used to remove unwanted matter such as sand particles or particles that are relatively heavy. Moreover, dirt particles and heavy particles may be removed by cyclones. Further, oils may be removed by oil separators, and density separation, size separation by vibrating, or other screening may also be used to remove the unwanted matter. The unwanted matter removed from the feedstock may be further recycled so as to be environmentally-friendly.

As further shown in FIG. 3, once the screened feedstock has been generated from step S302, the method 300 may proceed to step S303 thereof. According to at least one embodiment, step S303 of the method 300 includes preparing the screened feedstock to generate a prepared feedstock. In this regard, according to at least one embodiment, the step S303 of preparing the screened feedstock to generate the prepared feedstock may include subjecting the screened feedstock to a physical pretreatment process to downsize the screened feedstock and generate the prepared feedstock. Moreover, according to at least one embodiment, the step S303 of preparing the screened feedstock to generate the prepared feedstock may further include analyzing the prepared feedstock after the screened feedstock has been downsized so as to generate the prepared feedstock.

More specifically, with further regard to step S303 of the method 300, according to at least one embodiment, as non-limiting examples, subjecting the screened feedstock to the physical pretreatment process to downsize the screened feedstock may include subjecting the screened feedstock to at least one of a grinding process, a cutting process, a high-pressure homogenization process, a shear homogenization process, an electron beam process, a radiation process, a cavitation process, a sonication process, a vibration process, or a crushing process. Other physical pretreatment processes may be used to downsize the screened feedstock, and are not limited to the aforementioned non-limiting examples. Moreover, the particular physical pretreatment process may depend on such factors as whether the screened feedstock is solid or liquid, dry or wet, screened feedstock water content, screened feedstock chemical composition, bio solids in wastewater concentration of the screened feedstock, etc. Downsizing the screened feedstock (i.e., into smaller physical particles) by way of the physical pretreatment process advantageously allows the screened feedstock to be treated and processed more efficiently in subsequent steps of the method 300 that will be further described herein. With further regard to step S303 of the method 300, once the screened feedstock has been downsized by way of the physical pretreatment process so as to generate the prepared feedstock, the prepared feedstock may be analyzed to verify the prepared feedstock is ready to proceed to the subsequent step S304 of the method 300, which will be described later herein. According to at least one embodiment, as non-limiting examples, analyzing the prepared feedstock may include determining at least one of the weight, volume, acidity (pH), temperature, viscosity, or electrical conductivity (EC) of the prepared feedstock. Other qualities, quantities, reaction parameters, etc. of the prepared feedstock may be analyzed, and are not limited to the aforementioned non-limiting examples. Moreover, such analyzed qualities, quantities, reaction parameters, etc. of the prepared feedstock may be measured by scales, moisture analyzers, Spectro methods, or by using optics methods.

As further shown in FIG. 3, once the prepared feedstock has been generated from step S303, the method 300 may proceed to step S304 thereof. According to at least one embodiment, step S304 of the method 300 includes subjecting the prepared feedstock to a first reaction bath to generate an unrefined nanocellulose composition. In this regard, the first reaction bath, and any subsequent reaction baths (i.e., step S305), is capable of physically and chemically altering the prepared feedstock so as to physically and chemically break down (i.e., downsize) the cellulose fibers of the prepared feedstock (i.e., to a nano-sized scale), thereby generating the unrefined nanocellulose composition. According to at least one embodiment, the step S304 of subjecting the prepared feedstock to the first reaction bath to generate the unrefined nanocellulose composition may include conveying the prepared feedstock to the first reaction bath, subjecting the prepared feedstock to a physical reaction process of the first reaction bath, and subjecting the prepared feedstock to a chemical reaction process of the first reaction bath to generate the unrefined nanocellulose composition. Moreover, according to at least one embodiment, the step S304 of subjecting the prepared feedstock to the first reaction bath to generate the unrefined nanocellulose composition may include subjecting the prepared feedstock to a biochemical reaction process of the first reaction bath to generate the unrefined nanocellulose composition.

More specifically, with further regard to step S304 of the method 300, according to at least one embodiment, as non-limiting examples, conveying the prepared feedstock to the first reaction bath may include conveying the prepared feedstock to the first reaction bath by way of a conveyor netting, a pump, gravity, or air pressure. Other conveying apparatus or techniques may be used to convey the prepared feedstock to the first reaction bath and are not limited to the aforementioned non-limiting examples. With further regard to step S304 of the method 300, once the prepared feedstock has been conveyed to the first reaction bath, the prepared feedstock may be subjected to the physical reaction process of the first reaction bath, the chemical reaction process of the first reaction bath, and/or the biochemical reaction process of the first reaction bath. With further regard to step S304 of the method 300, according to at least one embodiment, as non-limiting examples, subjecting the prepared feedstock to the physical reaction process of the first reaction bath may include subjecting the prepared feedstock to at least one of a grinding process, a high-pressure homogenization process, a shear hydrolysis homogenization process, a hydrolysis process, a cavitation process, an electron beam process, a radiation process, a sonication process, a vibration process, a heating process, or a crushing process of the first reaction bath. Other physical reaction processes may be used to carry out the first reaction bath, and are not limited to the aforementioned non-limiting examples. The physical reaction process of the first reaction bath may refine, separate, and break down (i.e., downsize) the cellulose fibers of the prepared feedstock. With further regard to step S304 of the method 300, according to at least one embodiment, as non-limiting examples, subjecting the prepared feedstock to the chemical reaction process of the first reaction bath may include adding and mixing at least one selected from the group consisting of boric acid, formic acid, phosphoric acid, sodium hydroxide, hydrogen peroxide, trioxygen, citric acid, acetic acid, hydrobromide, hydrochloric acid, nitric acid, liquid ions, eutectic solvents, sodium chlorite, ethanol, carboxylic acid, phosphoric based acid, sulfuric based acids, TEMPO, polyethylene amine, deionized water, water, and any combination thereof, with the prepared feedstock. With further regard to step S304 of the method 300, according to at least one embodiment, as a non-limiting example, subjecting the prepared feedstock to the biochemical reaction process of the first reaction bath may include adding and mixing hydrolysis enzymes with the prepared feedstock. The particular chemicals, enzymes, etc. to be added and mixed with the prepared feedstock to carry out the chemical reaction process and/or the biochemical reaction process of the first reaction bath may depend on factors such as whether the prepared feedstock is solid or liquid, dry or wet, acidity (pH), electrical conductivity (EC), temperature, water content, viscosity, etc. As previously mentioned, such chemicals, enzymes, etc. described above may be used to carry out the chemical reaction process and/or the biochemical reaction process of the first reaction bath, however, other chemicals, enzymes, etc. not specifically mentioned may also be used to carry out the chemical reaction process and/or the biochemical reaction process of the first reaction bath. With further regard to step S304 of the method 300, the first reaction bath may also contain drainage for any liquids, and may sensor to monitor the acidity (pH), temperature, and electrical conductivity (EC), as well as the particle size of the generated unrefined nanocellulose composition. The physical and chemical reaction processes of the first reaction bath may range from 1 second to 1 day, a reaction temperature of the first reaction bath may range from 1 to 400° F., and the reaction pressure of the first reaction bath may range between −5 and 5 atm.

As further shown in FIG. 3, once the unrefined nanocellulose composition has been generated from step S304, the method 300 may proceed to step S305 thereof. According to at least one embodiment, step S305 of the method 300 includes optionally subjecting the prepared feedstock to one or more additional reaction baths, after the first reaction bath, to generate the unrefined nanocellulose composition. More specifically, with further regard to step S305 of the method 300, optional additional reaction baths (i.e., similar or varied) to the first reaction bath may be carried out (e.g., up to 50 or more additional reaction baths) to further physically and chemically break down (i.e., downsize) the cellulose fibers of the prepared feedstock (i.e., to a nano-sized scale), thereby generating the unrefined nanocellulose composition. In between each additional reaction bath, the liquid may be replaced, and various chemicals, enzymes, etc. may be added to the particular reaction bath to result in each reaction bath having a particular downsizing effect on the cellulose fibers of the prepared feedstock. In this regard, any number of additional reaction baths may be carried out until the desired unrefined nanocellulose composition is generated.

As further shown in FIG. 3, once the unrefined nanocellulose composition has been generated from step S304 and/or step S305 (i.e., in the case where the prepared feedstock has been optionally subjected to one or more additional reaction baths to generate the unrefined nanocellulose composition), the method 300 may proceed to step S306 thereof. According to at least one embodiment, step S306 of the method 300 includes washing the unrefined nanocellulose composition to generate a semi-refined nanocellulose composition. More specifically, with further regard to step S306 of the method 300, according to at least one embodiment, as non-limiting examples, washing the unrefined nanocellulose composition to generate the semi-refined nanocellulose composition may include washing the unrefined nanocellulose composition by way of a water immersion process, a water spray process, a dialysis process, a reverse osmosis process, or an acid removal process to thereby wash chemicals and/or unwanted reaction bath byproduct (i.e., further ending any ongoing reactions) from the unrefined nanocellulose composition and generate the semi-refined nanocellulose composition. Other washing processes or techniques may be used to wash the chemicals and/or unwanted reaction bath byproduct from the unrefined nanocellulose composition and are not limited to the aforementioned non-limiting examples.

As further shown in FIG. 3, once the semi-refined nanocellulose composition has been generated from step S306, the method 300 may proceed to step S307 thereof. According to at least one embodiment, step S307 of the method 300 includes separating the semi-refined nanocellulose composition to generate the nanocellulose composition 100. More specifically, with further regard to step S307 of the method 300, according to at least one embodiment, separating the semi-refined nanocellulose composition to generate the nanocellulose composition 100 may include separating the semi-refined nanocellulose composition from remaining unwanted reaction bath byproduct (e.g., that still remains from step S306) to generate the nanocellulose composition 100. The semi-refined nanocellulose composition may be separated from the remaining unwanted reaction bath byproduct by way of various separation equipment or techniques, as may be understood by those skilled in the art. Moreover, as shown in FIG. 4, according to at least one embodiment, the nanocellulose composition 100 may be undehydrated and in the form of a gel after the semi-refined nanocellulose composition is separated from the remaining unwanted reaction bath byproduct to generate the nanocellulose composition 100.

As further shown in FIG. 3, once the nanocellulose composition 100 has been generated from step S307, the method 300 may proceed to step S308 thereof. According to at least one embodiment, step S308 of the method 300 includes separating the nanocellulose composition 100 to exit a system (e.g., the particular system or machine at which the method 300 is carried out) at different exit points (i.e., places or areas). More specifically, with further regard to step S308 of the method 300, the separating of the nanocellulose composition 100 to exit the system at different exit points may be based on particle size and/or quality (e.g., zeta potential) of the nanocellulose composition 100. In this regard, as non-limiting examples, various size separation techniques, electro spin, or other spin technologies may be used to separate the nanocellulose composition 100 to exit the system at the different exit points.

As further shown in FIG. 3, once the nanocellulose composition 100 has been separated to exit the system at different exit points from step S308, the method 300 may proceed to step S309 thereof. According to at least one embodiment, step S309 of the method 300 includes optionally dehydrating the nanocellulose composition 100 to remove any water or moisture from the nanocellulose composition 100 and further physically stabilize the nanocellulose composition 100. In this regard, the nanocellulose composition 100 that is optionally dehydrated is initially in gel form, then may be in powder form after being dehydrated. As such, according to at least one embodiment, the nanocellulose composition 100 that has been optionally dehydrated may be in the form of a powder, as shown in FIG. 4.

As further shown in FIG. 3, once the nanocellulose composition 100 has been separated to exit the system at different exit points from step S308, and/or has been optionally dehydrated from step S309, the method 300 may proceed to step S310 thereof. According to at least one embodiment, step S310 of the method 300 includes finalizing the nanocellulose composition 100. In at least one embodiment, as non-limiting examples, finalizing the nanocellulose composition 100 may include adding and mixing at least one of additive polymers, additive chemicals, or additive metals with the nanocellulose composition 100 to finalize the nanocellulose composition 100. Adding such additive polymers, additive chemicals, additive metals, etc. to the nanocellulose composition 100 may advantageously customize the nanocellulose composition 100 for specific uses and applications in various industries, such as those previously described herein. Moreover, according to at least one embodiment, the nanocellulose composition 100 may be in the form of a powder or a gel after the nanocellulose composition 100 has been finalized (i.e., depending on whether the nanocellulose composition 100 has been optionally dehydrated in step S309 of the method 300).

As further shown in FIG. 3, once the nanocellulose composition 100 has been finalized from step S310, the method 300 may proceed to step S311 thereof. According to at least one embodiment, step S311 of the method 300 includes packaging the nanocellulose composition 100 after the nanocellulose composition 100 has been finalized. More specifically, as non-limiting examples, the nanocellulose composition 100 that has been finalized (i.e., finalized nanocellulose composition 100) may be packaged in pouches, boxes, containers, etc. in gel, powder, or other forms. Once packaged, the finalized nanocellulose composition 100 is ready to be shipped or distributed to customers, clients, etc.

While the method 300 of producing the nanocellulose composition 100 from a cotton-rich textile product has been described herein in great detail, it is to be understood that the nanocellulose composition 100 is not limited to being produced by way of the method 300, and as such, the nanocellulose composition 100 may be produced by way of other various methods which may vary from the method 300 described herein, as may be understood by those skilled in the art.

While one or more embodiments are described above, it is not intended that the one or more embodiments describe all possible forms encompassed by the claims. The words used in the specification are words of description rather than limitation, and it is understood that various changes may be made without departing from the spirit and scope of the disclosure. The features of various embodiments may be combined to form further embodiments of the disclosure that may not be explicitly described or illustrated.

With regard to any methods, processes, etc., described herein, it should be understood that, although the steps of such methods, processes, etc. have been described as occurring according to a certain ordered sequence, such methods, processes, etc. could be practiced with the described steps performed in an order other than the order described herein. It should be further understood that certain steps could be performed simultaneously, that other steps could be added, or that certain steps described herein could be omitted. In other words, the descriptions of any methods, processes, etc. described above are provided for the purpose of illustrating certain embodiments, and should in no way be construed so as to limit the claims.

As used in this specification and claims, the terms “for example”/(“e.g.”), “for instance”, “such as”, and “like”, and the verbs “comprising”, “having”, “including”, and their other verb forms, when used in conjunction with a listing of one or more carriers or other items, are each to be construed as open-ended, meaning that the listing is not to be considered as excluding other, additional carriers or items. Other terms are to be construed using their broadest reasonable meaning unless they are used in a context that requires a different interpretation.

What is claimed is:

1. A nanocellulose composition produced from a cotton-rich textile product, the nanocellulose composition comprising:
a nanocellulose content of 2% to 99% by weight of the nanocellulose composition;
a synthetic fiber content of 0.001% to 3% by weight of the nanocellulose composition; and
a mineral content of less than 9% by weight of the nanocellulose composition;
wherein an average particle size of the nanocellulose composition is in a range of 1 nanometer (nm) to 250 nanometers (nm); and
wherein a caloric value of the nanocellulose composition is in a range of 100 kilojoules (kJ) to 1803 kilojoules (kJ) or 20 kilocalories (kcal) to 360 kilocalories (kcal)/100 grams (g).

2. The nanocellulose composition according to claim 1, further comprising a hemicellulose content of 0.01% to 3% by weight of the nanocellulose composition.

3. The nanocellulose composition according to claim 1, further comprising a plastic content of less than 0.04% by weight of the nanocellulose composition.

4. The nanocellulose composition according to claim 1, further comprising a textile dye chemical content of 0.001% to 0.03% by weight of the nanocellulose composition.

5. The nanocellulose composition according to claim 1, further comprising a textile detergent content of less than 0.1% by weight of the nanocellulose composition.

6. The nanocellulose composition according to claim 1, further comprising a sand content of less than 1% by weight of the nanocellulose composition.

7. The nanocellulose composition according to claim 1, further comprising a dirt content of less than 0.2% by weight of the nanocellulose composition.

8. The nanocellulose composition according to claim 1, further comprising a metal content of less than 1% by weight of the nanocellulose composition.

9. The nanocellulose composition according to claim 1, wherein the nanocellulose composition is produced from a dry cotton-rich textile product, wherein the dry cotton-rich textile product is a feedstock used for producing the nanocellulose composition, and wherein a relative humidity (RH) of the feedstock is 35% or less.

10. The nanocellulose composition according to claim 9, wherein the dry cotton-rich textile product is new or used cotton-rich clothing.

11. The nanocellulose composition according to claim 1, wherein the nanocellulose composition is produced from a wet cotton-rich textile product, wherein the wet cotton-rich textile product is a feedstock used for producing the nanocellulose composition, and wherein a relative humidity (RH) of the feedstock is greater than 35%.

12. The nanocellulose composition according to claim 11, wherein the wet cotton-rich textile product is cotton-rich textile wastewater.

13. The nanocellulose composition according to claim 1, wherein the nanocellulose composition is in the form of a powder or a gel.

14. The nanocellulose composition according to claim 1, wherein the nanocellulose composition is used for producing at least one selected from the group consisting of a textile product, viscose, lyocell, a packaging product, a pulp product, a paper product, a plastic product, a 3D-printed product, a medical product, a sports product, a military product, an automobile component, an electric vehicle battery component, an aerospace product, a coating product, a construction product, a toy product, an additive used for producing and improving a polymer, an additive used for producing a resin used for 3D printing, and an additive used for producing a metal composition.

15. A textile product comprising the nanocellulose composition according to claim 1.

16. The textile product according to claim 15, wherein the textile product is viscose or lyocell.

17. A packaging product comprising the nanocellulose composition according to claim 1.

18. A pulp or paper product comprising the nanocellulose composition according to claim 1.

19. A plastic product comprising the nanocellulose composition according to claim 1.

20. A 3D-printed product comprising the nanocellulose composition according to claim 1.

21. A medical product comprising the nanocellulose composition according to claim 1.

22. A sports product comprising the nanocellulose composition according to claim 1.

23. A military product comprising the nanocellulose composition according to claim 1.

24. An automobile component comprising the nanocellulose composition according to claim 1.

25. An electric vehicle battery component comprising the nanocellulose composition according to claim 1.

26. An aerospace product comprising the nanocellulose composition according to claim 1.

27. A coating product comprising the nanocellulose composition according to claim 1.

28. A construction product comprising the nanocellulose composition according to claim 1.

29. A toy product comprising the nanocellulose composition according to claim 1.

30. An additive used for producing and improving a polymer, the additive comprising the nanocellulose composition according to claim 1.

31. An additive used for producing a resin used for 3D printing, the additive comprising the nanocellulose composition according to claim 1.

32. An additive used for producing a metal composition, the additive comprising the nanocellulose composition according to claim 1.
